(19) United States
(12) Patent Application Publication
(10) Pub. No.: US 2015/0362043 A1
(43) Pub. Date: Dec. 17, 2015

(54) GEARING SYSTEM

(71) Applicant: BENJAMIN J. PODURGIEL, III, NEW PORT RICHEY, FL (US)

(72) Inventor: BENJAMIN J. PODURGIEL, III, NEW PORT RICHEY, FL (US)

(21) Appl. No.: 14/303,198

(22) Filed: Jun. 12, 2014

(51) Int. Cl. F16H 1/22

(52) U.S. Cl. CPC F16H 1/22

(57) ABSTRACT

A housing has front, rear, left, right, top, and bottom faces are provided. A primary axis extends through bearing apertures of the front and rear faces. A secondary axis extends through bearing apertures of the left and right faces. A tertiary axis extends through bearing apertures of the top and bottom faces. First and second axles with first and second gears are rotatable around the primary axis. Third and fourth axles with third and fourth gears are rotatable around the second axis. Fifth and sixth axles with fifth and sixth gears are rotatable around the tertiary axis. One-to-one rotation of the fifth and sixth axles in opposite directions will cause one-to-one rotation of the first and second axles in opposite directions and one-to-one rotation of the third and fourth axles in opposite directions.

### BACKGROUND OF THE INVENTION

### Field of the Invention

The present invention relates to a gearing system and more particularly pertains to converting rotation of clockwise shafts in clockwise directions to rotation of counterclockwise shafts in counterclockwise directions opposite from the clockwise directions, each clockwise shaft having an associated counterclockwise shaft in axial alignment, the converting of the clockwise directions to the counterclockwise directions being in a one-to-one ratio, the converting being done in a safe, convenient, and economical manner.

### SUMMARY OF THE INVENTION

In view of the disadvantages inherent in the known types of gearing systems of known designs and configurations now present in the prior art, the present invention provides an improved gearing system. As such, the general purpose of the present invention, which will be described subsequently in greater detail, is to provide a new and improved gearing system and method which has all the advantages of the prior art and none of the disadvantages.

To attain this, the present invention essentially comprises a front face, a rear face, a left face, a right face, a top face, and a bottom face. Each face has a bearing aperture. A primary axis extends through the bearing apertures of the front and rear faces. A secondary axis extends through the bearing apertures of the left and right faces. A tertiary axis extends through the bearing apertures of the top and bottom faces.

Also provided are axles. First and second axles with first and second gears are rotatable around the primary axis. Third and fourth axles with third and fourth gears are rotatable around the second axis. Fifth and sixth axles with fifth and sixth gears are rotatable around the tertiary axis.

In this manner one-to-one rotation of the fifth and sixth axles in opposite directions will cause one-to-one rotation of the first and second axles in opposite directions. Also in this manner one-to-one rotation of the third and fourth axles in opposite directions is caused.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved gearing system which has all of the advantages of the prior art gearing systems of known designs and configurations and none of the disadvantages.

It is another object of the present invention to provide a new and improved gearing system which may be easily and efficiently manufactured and marketed.

It is a further object of the present invention to provide a new and improved gearing system which is of durable and reliable constructions.

An even further object of the present invention is to provide a new and improved gearing system which is susceptible of a low cost of manufacture with regard to both materials and labor, and which accordingly is then susceptible of low prices of sale to the consuming public, thereby making such gearing system economically available to the buying public.

Lastly, another object of the present invention is to provide a gearing system for converting rotation of clockwise shafts in clockwise directions to rotation of counterclockwise shafts in counterclockwise directions opposite from the clockwise directions, each clockwise shaft having an associated counterclockwise shaft in axial alignment, the converting of the clockwise directions to the counterclockwise directions being in a one-to-one ratio, the converting being done in a safe, convenient, and economical manner.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of a gearing system constructed in accordance with the principles of the invention.

FIGS. 2, 3, and 4 are cross sectional views taken along lines 2-2, 3-3, and 4-4 of FIG. 1.

FIG. 5 is a side elevational view of the first and second gears.

FIG. 6 is a side elevational view of the third and fourth gears.

FIG. 7 is a side elevational view of the fifth and sixth gears.

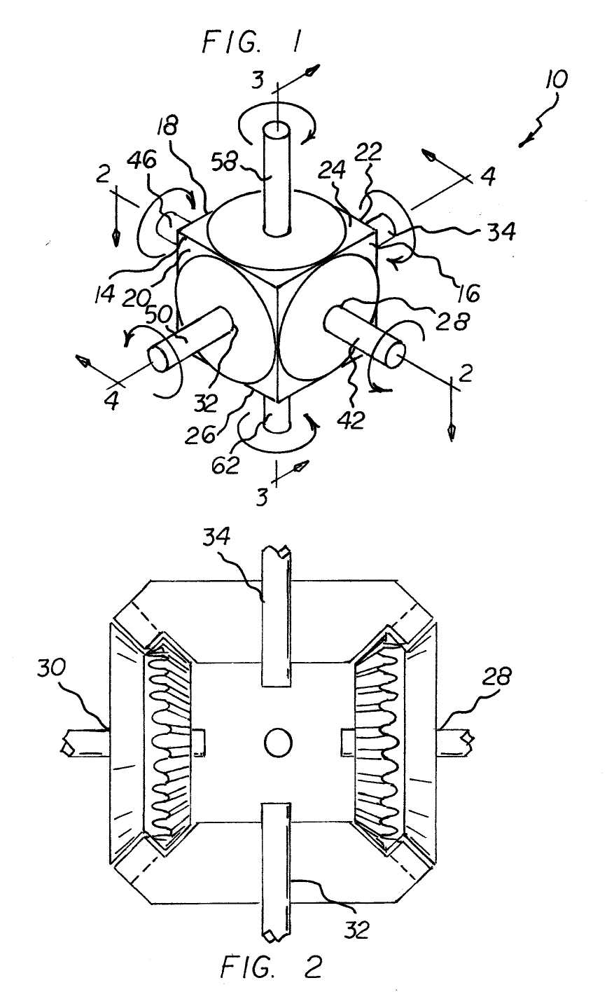

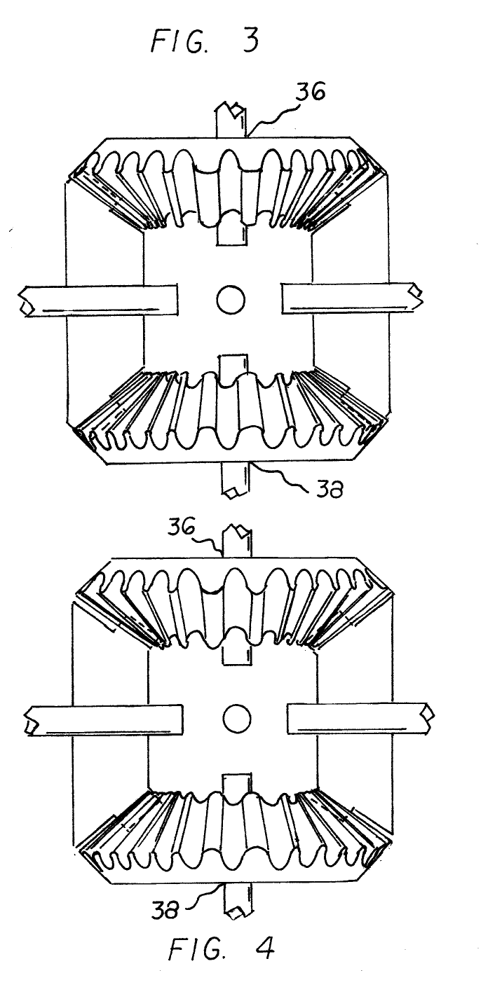

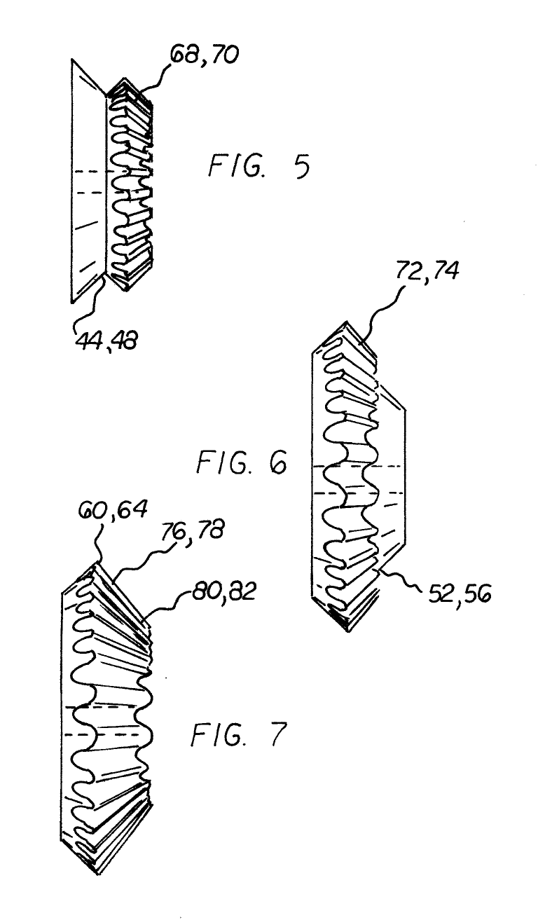

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved gearing system embodying the principles and concepts of the present invention and generally designated by the reference numeral 10 will be described.

The present invention, the gearing system 10 is comprised of a plurality of components. Such components in their broadest context include a front, rear, left, right, top and bottom faces; and first, second, third, fourth, fifth, and sixth axles with gears. Such components are individually configured and correlated with respect to each other so as to attain the desired objective.

First provided is a housing 14. The housing is in a cube-shaped configuration. The housing has a front face 16, a rear face 18, a left face 20, a right face 22, a top face 24, and a bottom face 26. A chamber is formed between the faces. The chamber has a midpoint. The front face has a first circular bearing aperture 28. The first circular bearing aperture is centrally located in the front face. The rear face has a second circular bearing aperture 30. The second circular bearing aperture is centrally located in the rear face. The left face has a third circular bearing aperture 32. The third circular bearing aperture is centrally located in the left face. The right face has a fourth circular bearing aperture 34. The fourth circular bearing aperture is centrally located in the right face. The top face has a fifth circular bearing aperture 36. The fifth circular bearing aperture is centrally located in the top face. The bottom face has a sixth circular bearing aperture 38. The sixth circular bearing aperture is centrally located in the bottom face. A primary axis is provided. The primary axis extends horizontally through the first and second bearing apertures. The primary axis also extends through midpoint of the chamber. A secondary axis is provided. The secondary axis extends horizontally through the third and fourth bearing apertures. The secondary axis also extends through the midpoint of the chamber. The secondary axis further is provided perpendicular to the first axis. A tertiary axis is provided. The tertiary axis extends vertically through the fifth and sixth bearing apertures. The tertiary axis also extends through the midpoint of the chamber. The tertiary axis is provided perpendicular to the first and second axes.

A first shaft 42 extends through the first bearing aperture with a first bevel gear 44 within the chamber adjacent to the front face. A second shaft 46 extends through the second bearing aperture with a second bevel gear 48 within the chamber adjacent to the rear face. A third shaft 50 extends through the third bearing aperture with a third bevel gear 52 within the chamber adjacent to the left face. A fourth shaft 54 extends through the fourth bearing aperture with a fourth bevel gear 56 within the chamber adjacent to the right face. A fifth shaft 58 extends through the fifth bearing aperture with a fifth bevel gear 60 within the chamber adjacent to the top face. A sixth shaft 62 extends through the sixth bearing aperture with a sixth bevel gear 64 within the chamber adjacent to the bottom face;

Further provided are first and second bevel gears. The first and second bevel gears have axially interior halves. The axially interior halves of the first and second bevel gears have teeth 68, 70. The first and second bevel gears have axially exterior halves. The axially exterior halves of the first and second bevel gears do not have teeth. The first and second gears are rotatable around the primary axis. The third and fourth bevel gears have axially exterior halves. The axially exterior halves of the third and fourth bevel gears have teeth 72, 74. The third and fourth bevel gears have axially interior halves. The axially interior halves of the third and fourth bevel gears do not have teeth. The third and fourth gears being rotatable around the secondary axis. The fifth and sixth bevel gears have axially exterior halves. The axially exterior halves of the fifth and sixth bevel gears have teeth 76, 78. The fifth and sixth bevel gears have axially interior halves. The axially interior halves of the fifth and sixth bevel gears have teeth 80, 82. The fifth and sixth gears are rotatable around the tertiary axis.

The interior teeth of the fifth and sixth gears are in meshing engagement with the interior teeth of the first and second gears. In this manner the rotation of the fifth and sixth axles equally one-to-one in opposite directions will cause rotation of the first and second axles in equally one-to-one in opposite directions. The exterior teeth of the fifth and sixth gears are in meshing engagement with the exterior teeth of the third and fourth gears. In this manner the rotation of the fifth and sixth axles equally one-to-one in opposite directions will cause rotation of the third and fourth axles in equally one-to-one in opposite directions.

It should be understood that the gears with only interior teeth or with only exterior teeth may be fabricated as such or, in the alternative, such gears may be fabricated with both interior teeth and exterior teeth and then cut to remove half of their teeth appropriately.

It should be further understood that although the primary embodiment shows a system with six axles and six gears, the invention is equally applicable to systems with three axles and three gears or to systems with four axles and four gears or to systems with five axles and five gears. As such, the invention includes a gearing system which includes a housing with a primary bearing aperture, a secondary bearing aperture, and a tertiary bearing aperture. The primary bearing aperture is located in the housing with a primary axis extending through the primary bearing aperture. The secondary bearing aperture is located in the housing, with a secondary axis extending through the secondary bearing aperture, and with the secondary axis being perpendicular to the primary axis. The tertiary bearing aperture is located in the housing, with a tertiary axis extending through the tertiary bearing aperture, and with the tertiary axis being perpendicular to both the primary axis and the secondary axis. A primary axle with a primary gear is rotatable around the primary axis. The primary gear is a bevel gear with both radially interior teeth and radially exterior teeth. A secondary axle with a secondary gear is rotatable around the secondary axis. The secondary gear is a bevel gear with only radially interior teeth. A tertiary axle with a tertiary gear is rotatable around the tertiary axis. The tertiary gear is a bevel gear with only radially exterior teeth.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A gearing system comprising:
a front face, a rear face, a left face, a right face, a top face, and a bottom face, a bearing aperture located in each face, a primary axis extending through the bearing apertures of the front and rear faces, a secondary axis extending through the bearing apertures of the left and right faces, a tertiary axis extending through the bearing apertures of the top and bottom faces; and
first and second axles with first and second gears rotatable around the primary axis, third and fourth axles with third and fourth gears rotatable around the second axis, fifth and sixth axles with fifth and sixth gears rotatable around the tertiary axis;
whereby one-to-one rotation of the fifth and sixth axles in opposite directions will cause one-to-one rotation of the first and second axles in opposite directions, and one-to-one rotation of the third and fourth axles in opposite directions.

2. The system as set forth in claim 1 wherein the faces form a housing in a cube-shaped configuration, the faces forming a chamber with the gears located within the chamber, the primary and secondary axes being at right angles with respect to each other, and the tertiary axis at right angles to the primary and secondary axes.

3. The system as set forth in claim 1 wherein the first and second gears are bevel gears having axially interior halves with teeth and axially exterior halves without teeth, and wherein the third and fourth gears are bevel gears having axially exterior halves with teeth and axially interior halves without teeth, and wherein the fifth and sixth gears are bevel gears having axially exterior halves with teeth and axially interior halves with teeth.

4. A gearing system comprising:
a housing;
a primary bearing aperture located in the housing, a primary axis extending through the primary bearing aperture;
a secondary bearing aperture located in the housing, a secondary axis extending through the secondary bearing aperture, the secondary axis being perpendicular to the primary axis;
a tertiary bearing aperture located in the housing, a tertiary axis extending through the tertiary bearing aperture, the tertiary axis being perpendicular to both the primary axis and the secondary axis;
a primary axle with a primary gear rotatable around the primary axis, the primary gear being a bevel gear with both radially interior teeth and radially exterior teeth;
a secondary axle with a secondary gear rotatable around the secondary axis, the secondary gear being a bevel gear with only radially interior teeth; and
a tertiary axle with a tertiary gear rotatable around the tertiary axis, the tertiary gear being a bevel gear with only radially exterior teeth.

5. A gearing system (10) for converting rotation of clockwise shafts in clockwise directions to rotation of counterclockwise shafts in counterclockwise directions opposite from the clockwise directions, each clockwise shaft having an associated counterclockwise shaft in axial alignment, the converting of the clockwise directions to the counterclockwise directions being in a one-to-one ratio, the converting being done in a safe, convenient, and economical manner, the system comprising, in combination:
a housing (14) in a cube-shaped configuration with a front face (16), a rear face (18), a left face (20), a right face (22), a top face (24), and a bottom face (26), a chamber formed between the faces, the chamber having a midpoint, a first circular bearing aperture (28) centrally located in the front face, a second circular bearing aperture (30) centrally located in the rear face, a third circular bearing aperture (32) centrally located in the left face, a fourth circular bearing aperture (34) centrally located in the right face, a fifth circular bearing aperture (36) centrally located in the top face, a sixth circular bearing aperture (38) centrally located in the bottom face, a primary axis extending horizontally through the first and second bearing apertures and the midpoint of the chamber, a secondary axis extending horizontally through the third and fourth bearing apertures and the midpoint of the chamber and perpendicular to the first axis, a tertiary axis extending vertically through the fifth and sixth bearing apertures and the midpoint of the chamber perpendicular to the first and second axes;
a first shaft (42) extending through the first bearing aperture with a first bevel gear (44) within the chamber adjacent to the front face, a second shaft (46) extending through the second bearing aperture with a second bevel gear (48) within the chamber adjacent to the rear face, a third shaft (50) extending through the third bearing aperture with a third bevel gear (52) within the chamber adjacent to the left face, a fourth shaft (54) extending through the fourth bearing aperture with a fourth bevel gear (56) within the chamber adjacent to the right face, a fifth shaft (58) extending through the fifth bearing aperture with a fifth bevel gear (60) within the chamber adjacent to the top face, a sixth shaft (62) extending through the sixth bearing aperture with a sixth bevel gear (64) within the chamber adjacent to the bottom face;
the first and second bevel gears having axially interior halves with teeth (68), (70), the first and second bevel gears having axially exterior halves without teeth, the first and second gears being rotatable around the primary axis, the third and fourth bevel gears having axially exterior halves with teeth (72), (74), the third and fourth bevel gears having axially interior halves without teeth, the third and fourth gears being rotatable around the secondary axis, the fifth and sixth bevel gears having axially exterior halves with teeth (76), (78), the fifth and sixth bevel gears having axially interior halves with teeth (80), (82), the fifth and sixth gears being rotatable around the tertiary axis; and
wherein the interior teeth of the fifth and sixth gears are in meshing engagement with the interior teeth of the first and second gears so that the rotation of the fifth and sixth axles equally one-to-one in opposite directions will cause rotation of the first and second axles in equally one-to-one in opposite directions, and wherein the exterior teeth of the fifth and sixth gears are in meshing engagement with the exterior teeth of the third and fourth gears so that the rotation of the fifth and sixth axles equally one-to-one in opposite directions will cause rotation of the third and fourth axles in equally one-to-one in opposite directions.
